(19) United States
(12) Patent Application Publication
(10) Pub. No.: US 2010/0050229 A1
(43) Pub. Date: Feb. 25, 2010

(54) VALIDATING NETWORK SECURITY POLICY COMPLIANCE

(75) Inventor: Linwood Hugh Overby, JR., Raleigh, NC (US)

Correspondence Address: IBM Corporation-Raleigh SWG;c/o Thomas, Raring & Teague, P.C, 536 Granite Avenue, Richmond, VA, 23226, US

(73) Assignee: International Business Machines Corporation, Armonk, NY (US)

(21) Appl. No.: 12/193,989

(22) Filed: Aug. 19, 2008

(51) Int. Cl. H04L 9/00

(52) U.S. Cl. 726/1

(57) ABSTRACT

The present invention may provide the ability to determine the actions triggered by a network security policy given a set of conditions. Embodiments of the invention involve testing the security policy at specified times, documenting and analyzing the test results for compliance, recording the results for auditing purposes, writing events to warn of non-compliance findings, and dynamically taking defensive action to prevent security breaches as the result of non-compliance findings.

### BACKGROUND

The present invention relates to computer network security.

A network security policy comprises a collection of policy rules. The policy rules comprise conditions and actions. The condition portion of the rule describes the conditions that must be present before a rule action is taken. Example conditions include information in a packet header (IP (Internet protocol) addresses, ports, protocols), direction of packet, user ID, application name, and time of day. Policy conditions for a rule can be configured to use any combination of allowed condition attributes. Actions describe the security actions to take under specified circumstances, such as deny or drop a packet, allow a packet, or require network encryption protocols (e.g., IP security (IPSec) or transport layer security (TLS)).

FIG. 1 is a schematic block diagram of a prior art computer network in which embodiments of the present invention may operate. Server 12 and computers 14 provide processing, storage, and input/output devices executing application programs and the like. Server 12 and computers 14 may be linked through a public communications network to each other and to other computing devices. Communications network 10 can be part of the Internet, a worldwide collection of computers, networks, and gateways that currently use the TCP/IP (Transmission Control Protocol/Internet Protocol) suite of protocols to communicate with one another. The Internet provides a backbone of high-speed data communication lines between major nodes or host computers, consisting of thousands of commercial, government, educational, and other computer networks, that route data and messages. Other devices, such as server 20 and computers 22 may be linked through a private communications network, such as intranet 16. Communications between devices on the public network and devices on the private network may be controlled by an enforcement point, such as firewall 18. An enforcement point performs various security actions on traffic coming into and going out of the network based on a set of conditions An enforcement point may be located at network ingress/egress points, or elsewhere in a network (such as in a server or client computer. A network may comprise many sub-networks and thus may have many enforcement points. An enforcement point typically comprises a device configured to permit, deny, encrypt, or proxy all computer traffic between the network in which the enforcement point is located and other networks based upon the policy rules.

The policy rules are typically established by one or more network administrators. A network may have hundreds of policy rules in place, and the rules are often changed by an administrator as new connectivity is desired or applications are added. Because of the numerous combinations of possible conditions, it is difficult to verify that a network security policy is functioning as desired. Once a policy is created, it is difficult for an administrator to know whether the security policy is properly implemented in all enforcement points. It is difficult to predict the effect of adding or deleting additional rules after initial policy creation. Administrators also would like to verify and document that the policy rules implement the correct security policy over a time period.

### BRIEF SUMMARY

The present invention may provide the ability to determine the actions triggered by a network security policy given a set of conditions. Embodiments of the invention involve testing the security policy at specified times, documenting and analyzing the test results for compliance, recording the results for auditing purposes, writing events to warn of non-compliance findings, and dynamically taking defensive action to prevent security breaches as the result of non-compliance findings.

In one embodiment of the invention, a method for validating network security policy compliance comprises creating a plurality of condition simulators for testing a network security policy, each condition simulator having a corresponding expected result, and comparing a result of a test of the network security policy using one of the condition simulators to the expected result corresponding to the one of the condition simulators.

Each of the plurality of condition simulators may comprise at least packet header information and packet direction. The packet header information may comprise a destination Internet Protocol address, a source Internet Protocol address, a communication protocol, a destination port, and a source port. Each of the plurality of condition simulators may further comprise at least one of a time of day, a user identity, and an application name.

The method may further comprise sending the one of the condition simulators to a network security enforcement point at which the test of the network security policy is performed, and receiving the result of the test of the network security policy.

The method may further comprise performing one or more remedial actions if the result of the test of the network security policy using the one of the condition simulators does not conform to the expected result corresponding to the one of the condition simulators.

In addition to the method for validating network security policy compliance, as described above, other aspects of the present invention are directed to corresponding systems and computer program products for validating network security policy compliance.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a prior art computer network in which embodiments of the present invention may operate;

FIG. 2 is a schematic block diagram of a system for validating network security compliance, in accordance with one embodiment of the present invention;

FIG. 3 is a schematic block diagram of a system for validating network security compliance, in accordance with an alternative embodiment of the present invention; and

FIG. 4 is a schematic block diagram of an element of the system of FIG. 2.

### DETAILED DESCRIPTION

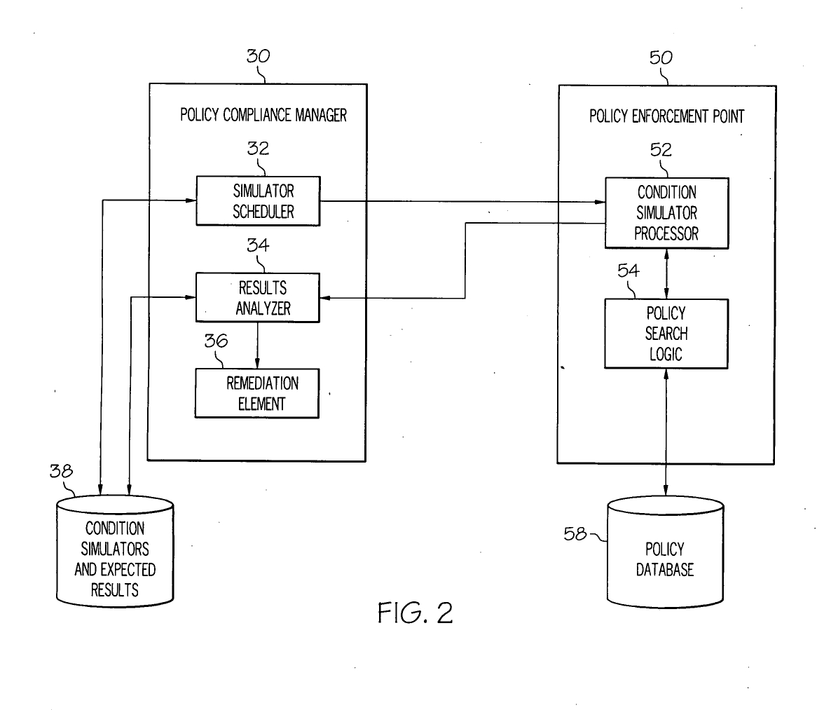

Referring now to FIG. 2, a schematic block diagram of a system for validating network security compliance is illustrated in accordance with one embodiment of the present invention. In the embodiment of FIG. 2, the system of validating network security compliance comprises a policy compliance manager 30 and special software code at the policy enforcement point 50. Policy compliance manager 30 may reside on a server or computer controlled by a network administrator. Policy enforcement point 50 may be, for example, a firewall controlling network traffic into and out of a network. In known network security methods, an incoming or outgoing packet is received by the enforcement point. The policy search logic 54 retrieves the appropriate filter rules from the policy database 58 and determines whether the packet should be allowed. Typically, the policy database 58 is cached in memory for more efficient policy processing. The policy search logic 54 is called for each packet that is to be evaluated. The policy search logic compares runtime conditions, such as select attributes from the packets, packet direction, time of day, and system conditions, with configured conditions in a filter rule. Each filter rule is checked in priority order, until a match of runtime conditions and filter conditions is found. Once a match is found, the policy search logic returns the action from the filter rule to the caller of the policy lookup logic where security enforcement can be performed by executing the required action (e.g., deny the packet). Embodiments of the present invention enable these known network security methods to be verified to be working as desired, either before implementation or after implementation (i.e., “live”).

A set of condition simulators used to drive a policy compliance check are created, and stored in database 38. The condition simulators are used to simulate the behavior of the security policy if a “live” packet that contained the same 5-tuples (destination IP address, source IP address, protocol, destination port, source port) as the condition simulators, under a certain set of other conditions (e.g., direction, time), were processed by the policy search logic. For example, one condition simulator may contain the following information:
(a) destination IP address—IP address of local server being tested;
(b) source IP address—IP address of business partner;
(c) protocol—TCP;
(d) destination port—21 (file transfer protocol (FTP));
(e) source port—50000 (from ephemeral port range);
(f) direction—inbound; and
(g) time of day—08:00 PM EST.
   The specific conditions contained in the condition simulators will typically vary based on the communications protocol that is being used. For example, not all communications protocols have destination port and source ports (TCP and User Datagram Protocol do, but Internet Control Message Protocol and Open Shortest Path First protocol do not), so those conditions would not be used in all condition simulators.

For each condition simulator there is an associated expected result, also stored in database 38. Such an expected result may include overall action (deny, allow), type of network security required (IPSec, TLS), encryption algorithm required, and authentication algorithms required. An example of an expected result for a given condition simulator test packet is:
(a) action—packet allowed;
(b) security required—IPSec required;
(c) encryption algorithms required—AES; and
(d) authentication algorithms required—HMAC-SHA.

The policy compliance manager 30 may comprise a simulator scheduler 32 configured for conducting policy validation tests on a scheduled or ad hoc basis. The scheduler retrieves one or more condition simulators from the database 38 and sends them over the network to the policy enforcement point 50 (the remainder of the method will be described as if only one condition simulator is sent from the policy compliance manager to the policy enforcement point). The policy enforcement point comprises software code to implement a condition simulator processor 52. The condition simulator processor receives the condition simulator and invokes the policy search logic 54. The policy search logic 54 works as described above, retrieving the appropriate filter rules from the policy database 58 and applying the rules to determine if the condition simulator should be allowed or denied. Other security session information is also determined according to the policy rules, such as security protocol type (e.g., IPSec or TLS) and cryptographic algorithms associated with the condition simulator.

The result of the test from the policy search logic is sent via the condition simulator processor to the policy compliance manager. The policy compliance manager comprises a results analyzer 34 which compares the received test result to the result that is expected for the condition simulator that was used. A remediation element 36 may then take one or more actions based on the results of the analysis. If the analysis shows a mismatch between the returned results and the expected results, a non-compliance condition occurs. The action taken if a non-compliance condition is found may be determined based on when policy verification is performed (i.e., before or after implementation of a security policy). The number and type of action taken may vary depending on the severity of the non-compliance condition and/or the number of rules that yield non-compliance conditions.

In the event of a non-compliance condition resulting from a pre-installation test, the remedial action would generally be to not install the tested policy. In the event of a non-compliance condition for live policy check, as mentioned above the type of action taken may vary depending on the severity of the non-compliance condition and/or the number of rules that yield non-compliance conditions. For example, if the non-compliance condition is that one filter that controls access from a business partner to FTP fails, the remediation element 36 may write a message to a security administrator and install a defensive filter rule to block access to FTP from that source IP address for 30 minutes. In another example, if the non-compliance condition is that multiple filters for access to FTP fail, the remediation element 36 may write message to a security administrator and install defensive filter rule to block all access to FTP for 30 minutes.

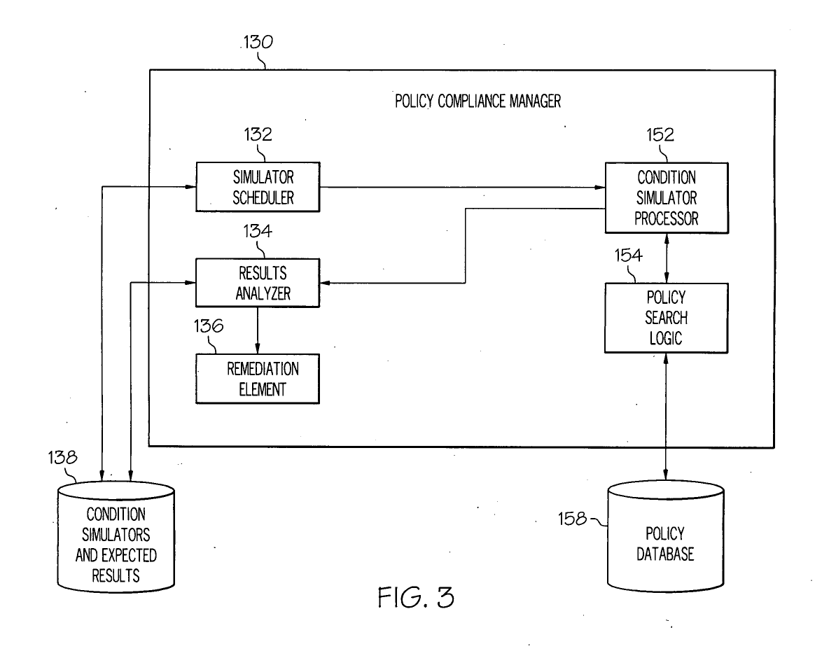

FIG. 2 illustrates a system used for live policy validation, as the policy enforcement point 50 implements the live security policy. The policy compliance manager and the policy enforcement point comprise two functions that may be collocated on the same system or on different systems. A system for pre-installation policy validation may and likely would be implemented in a single device accessible to the security administrator. FIG. 3 illustrates such a system for pre-installation policy validation, in accordance with one embodiment of the invention. The system of FIG. 3 comprises a policy compliance manager 130, the components of which are similar to the combined components of the policy compliance manager 30 and the policy enforcement point 50 of FIG. 2. The policy compliance manager 130 may comprise a simulator scheduler 132 configured for conducting policy validation tests on a scheduled or ad hoc basis. As pre-installation testing would likely be performed on an ad hoc basis, the simulator scheduler 132 may be omitted. The scheduler retrieves the condition simulator to be tested prior to installation (such as from the database 138) and sends it to the condition simulator processor 152. The condition simulator processor receives the condition simulator and invokes the policy search logic 154. The policy search logic 154 would typically be a duplicate of the policy search logic in place at the enforcement point(s) at which the new policy is to be installed (if the pre-installation test is successful) in order to ensure a valid test. The policy search logic 154 works as described above, retrieving the appropriate filter rules from the policy database 158 (which is also a duplicate of the policy database in place at the enforcement point(s) at which the new policy is to be installed) and applying the rules to determine if the condition simulator should be allowed or denied. The result of the pre-installation test from the policy search logic 154 is sent via the condition simulator processor 152 to the results analyzer 134 which compares the received test result to the result that is expected for the condition simulator that was used. A remediation element 136 may then take action based on the results of the analysis, as described above.

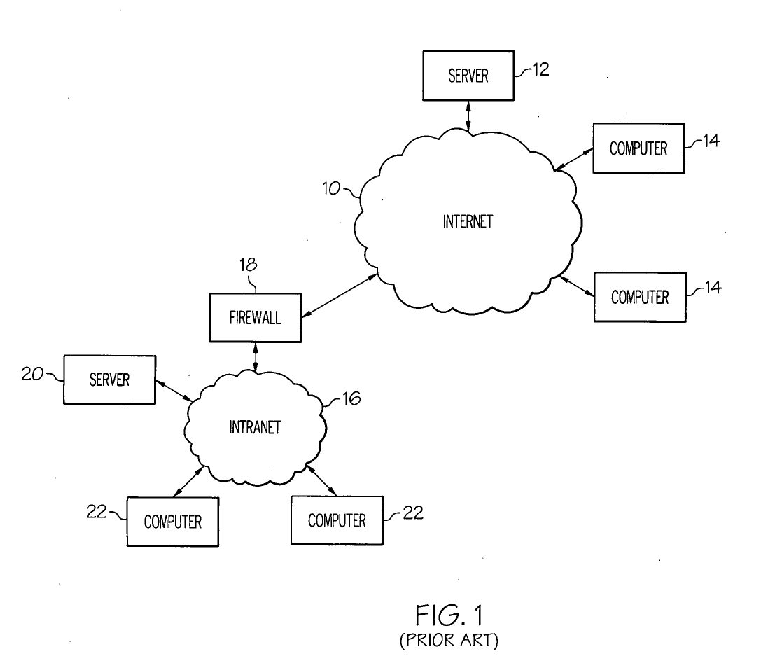

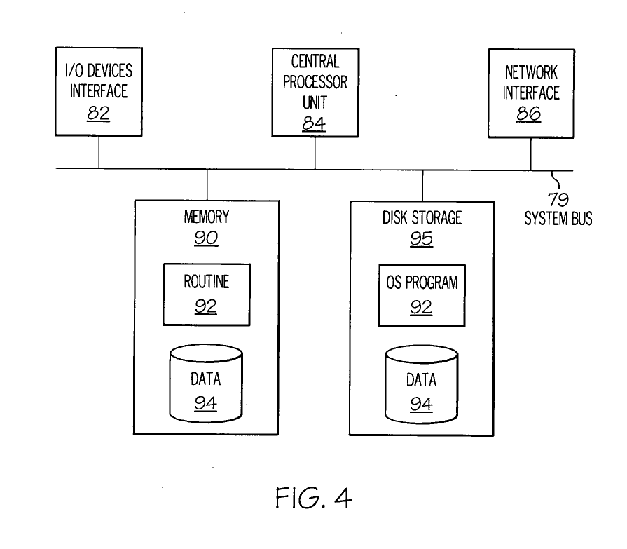

FIG. 4 is a diagram of the internal structure of a computer that may function as one or more elements (e.g., policy compliance manager 30, policy enforcement point 50, or policy compliance manager 130) of a system for network security policy validation in accordance with embodiments of the invention. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, etc.) to the computer. Network interface 86 allows the computer to connect to various other devices attached to a network (e.g., network 10 or 16 of FIG. 1). Memory 90 provides volatile storage for computer software instructions used to implement an embodiment of the present invention. Disk storage 95 provides non-volatile storage for computer software instructions and data used to implement an embodiment of the present invention. Central processor unit 84 is also attached to system bus 79 and provides for the execution of computer instructions.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method of validating network security policy compliance, the method comprising:
creating a plurality of condition simulators for testing a network security policy, each condition simulator having a corresponding expected result; and
comparing a result of a test of the network security policy using one of the condition simulators to the expected result corresponding to the one of the condition simulators.

2. The method of claim 1, wherein each of the plurality of condition simulators comprises at least packet header information and packet direction.

3. The method of claim 2, wherein the packet header information comprises a destination Internet Protocol address, a source Internet Protocol address, a communication protocol, a destination port, and a source port.

4. The method of claim 2, wherein each of the plurality of condition simulators further comprises at least one of a time of day, a user identity, and an application name.

5. The method of claim 1, further comprising:
sending the one of the condition simulators to a network security enforcement point at which the test of the network security policy is performed; and
receiving the result of the test of the network security policy.

6. The method of claim 1, further comprising:
performing one or more remedial actions if the result of the test of the network security policy using the one of the condition simulators does not conform to the expected result corresponding to the one of the condition simulators.

7. A system for validating network security policy compliance, the system comprising:
a processing element configured for creating a plurality of condition simulators for testing a network security policy, each condition simulator having a corresponding expected result; the processing element further configured for comparing a result of a test of the network security policy using one of the condition simulators to the expected result corresponding to the one of the condition simulators.

8. The system of claim 7, wherein each of the plurality of condition simulators comprises at least packet header information and packet direction.

9. The system of claim 8, wherein the packet header information comprises a destination Internet Protocol address, a source Internet Protocol address, a communication protocol, a destination port, and a source port.

10. The system of claim 8, wherein each of the plurality of condition simulators further comprises at least one of a time of day, a user identity, and an application name.

11. The system of claim 7, wherein the processing element is further configured for sending the one of the condition simulators to a network security enforcement point at which the test of the network security policy is performed; and wherein the processing element is further configured for receiving the result of the test of the network security policy.

12. The system of claim 7, wherein the processing element is further configured for performing one or more remedial actions if the result of the test of the network security policy using the one of the condition simulators does not conform to the expected result corresponding to the one of the condition simulators.

13. A computer program product for validating network security policy compliance, the computer program product comprising at least one computer-readable storage medium having computer-readable program code stored therein, the computer-readable program code comprising:
computer-usable program code for creating a plurality of condition simulators for testing a network security policy, each condition simulator having a corresponding expected result; and
computer-usable program code for comparing a result of a test of the network security policy using one of the condition simulators to the expected result corresponding to the one of the condition simulators.

14. The computer program product of claim 13, wherein each of the plurality of condition simulators comprises at least packet header information and packet direction.

15. The computer program product of claim 14, wherein the packet header information comprises a destination Internet Protocol address, a source Internet Protocol address, a communication protocol, a destination port, and a source port.

16. The computer program product of claim 14, wherein each of the plurality of condition simulators further comprises at least one of a time of day, a user identity, and an application name.

17. The computer program product of claim 13, further comprising:
computer-usable program code for sending the one of the condition simulators to a network security enforcement point at which the test of the network security policy is performed; and
computer-usable program code for receiving the result of the test of the network security policy.

18. The computer program product of claim 13, further comprising:
computer-usable program code for performing one or more remedial actions if the result of the test of the network security policy using the one of the condition simulators does not conform to the expected result corresponding to the one of the condition simulators.
